(19) United States
(12) Patent Application Publication
(10) Pub. No.: US 2016/0369975 A1
(43) Pub. Date: Dec. 22, 2016

(54) QUANTUM DOT-CONTAINING WAVELENGTH CONVERTER

(71) Applicant: National Tsing Hua University, Hsinchu City (TW)

(72) Inventors: Hsueh-Shih CHEN, Hsinchu City (TW); Shih-Jung HO, Tainan City (TW); Guan-Hong CHEN, Kaohsiung City (TW); Ming-Hua YEH, Taichung City (TW)

(73) Assignee: National Tsing Hua University, Hsinchu City (TW)

(21) Appl. No.: 14/746,433

(22) Filed: Jun. 22, 2015

(51) Int. Cl. F21V 9/16; C09K 11/88

(52) U.S. Cl. CPC F21V 9/16; C09K 11/883; Y10S 977/774; B82Y 20/00

(57) ABSTRACT

A quantum dot-containing wavelength converter includes a matrix layer and quantum dots dispersed in the matrix layer. Each of the quantum clots includes a core of a compound M1A1, an inner shell, and a multi-pod-structured outer shell of a compound M1A2 or M2A2. Each of M1 and M2 is a metal selected from Zn, Sn, Pb, Cd, In, Ga, Ge, Mn, Co, Fe, Al, Mg, Ca, Sr, Ba, Ni, Ag, Ti and Cu, and each of A1 and A2 is an element selected from Se, S, Te, P, As, N, I, and O. The inner shell contains a compound M1ₓM2₁₋ₓAl_{y}A2_{1-y}, wherein M2 is different from M1 and A2 is different from A1. The multi-pod-structured outer shell has a base portion and protrusion portions that extend from the base portion in a direction away from the inner shell.

### FIELD

The disclosure relates to a quantum dot-containing wavelength converter, more particularly to a quantum dot-containing wavelength converter including a matrix layer and a plurality of quantum dots dispersed in the matrix layer.

### BACKGROUND

U.S. Patent Application Publication No. 2011/0006285 discloses a core-alloyed shell semiconductor nanocrystal that includes a core of a semiconductor material, a core-overcoating shell enclosing the core, and an outer organic ligand layer. The semiconductor material may be selected from PbS, PbSe, PbTe, CdTe, InN, InP, InAs, InSb, HgS, HgSe, and GaSb when the band gap energy of the semiconductor material is in the infrared energy range, and may be selected from CdSe, CdTe, ZnSe, ZnTe, AlAs, AlP, AlSb, AlN, GaP and GaAs when the band gap energy of the semiconductor material is in the visible energy range.

U.S. Patent Application Publication No. 2013/0032767 discloses an octapod shaped, nanocrystal that includes a core and eight pods. The core includes a material crystallized in a cubic phase and having eight developed {111} facets. The pods are crystallized in a hexagonal phase on the eight {111} facets, and have a length greater than 5 nm.

In the prior art, the core-alloyed shell semiconductor nanocrystal is not in the stable form and would, be quickly photooxidized under light illumination. The inclusion of the pods in the nanocrystal may enhance the stability and quantum efficiency of the nanocrystal. However, the pods of the conventional nanocrystal may easily break, which results in a decrease in the stability and quantum efficiency of the nanocrystal.

U.S. Pat. No. 8,455,898 discloses a lighting device that includes a light source layer and a plurality of quantum dot-containing luminescent layers stacked on the light source layer. The quantum dot-containing luminescent layers have refractive indices that gradually decrease from the quantum dot-containing luminescent layer that is adjacent to the light source layer toward the quantum dot-containing luminescent layer that is most distal from the light source layer, so that reflection of a light generated from the light source layer back to the light source layer can be reduced. The entire disclosure of the aforesaid patent is incorporated herein by reference.

### SUMMARY

An object of the disclosure is to provide a quantum dot-containing wavelength converter that may overcome at least one of the aforesaid drawbacks associated with the prior art.

According to the current disclosure, there is provided a quantum dot-containing wavelength converter that includes a matrix layer of a light transmissible material, and a plurality of quantum dots dispersed in the matrix layer. Each of the quantum dots includes a core of a compound M1A1, an inner shell, and a multi-pod-structured outer shell of a compound M1A2 or M2A2, M1 is a metal selected from the group consisting of Zn, Sn, Pb, Cd, In, Ga, Ge, Mn, Co, Fe, Al, Mg, Ca, Sr, Ba, Ni, Ag, Ti and Cu, and A1 is an element selected from the group consisting of Se, S, Te, P, As, N, I, and O. The inner shell encloses the core and has a composition containing a compound M1ₓM2₁₋ₓA1_{y}A2_{1-y}, wherein M2 is different from M1 and is a metal selected from the group consisting of Zn, Sn, Pb, Cd, In, Ga, Ge, Mn, Co, Fe, Al, Mg, Ca, Sr, Ba, Ni, Ag, Ti and Cu, A2 is different from A1 and is an element selected from the group consisting of Se, S, Te, P, As, N, I and O, 0<x≦1, 0<y<1, and y decreases over a layer thickness of the inner shell in a direction from the core toward the inner shell. The multi-pod-structured outer shell encloses the inner shell, and has a base portion and a plurality of protrusion portions that are spaced apart from one another and that extend from the base portion in a direction away from the inner shell.

### BRIEF DESCRIPTION OF THE DRAWINGS

In drawings which illustrate embodiments of the disclosure,

FIG. 1 is a schematic view of the first embodiment of a quantum dot-containing wavelength converter according to the disclosure;

FIG. 2 is a schematic view to illustrate the structure of a quantum dot of the first embodiment;

FIG. 3 is a schematic view to illustrate the structure of a quantum dot of the second embodiment;

FIG. 4 is a schematic view of the third embodiment of the quantum dot-containing wavelength converter according to the disclosure;

FIG. 5 is a schematic view of the fourth embodiment of the quantum dot-containing wavelength converter according to the disclosure;

FIG. 6 is a schematic view of the fifth embodiment of the quantum dot-containing wavelength converter according to the disclosure;

FIG. 7 is a schematic view of the sixth embodiment of the quantum dot-containing wavelength converter according to the disclosure;

FIG. 8 is a plot of luminous intensity vs. wavelength illustrating the results of a light emission wavelength of quantum dots of Example 1;

FIGS. 9 and 10 are TEM images showing the shape and structure of the quantum dots of Example 1;

FIG. 11 is a TEM image of the quantum dot of Example 1 accompanied with inserted FFT (Fourier Transform) images and simulated lattice images that illustrate the structures of different zones of the quantum dot of Example 1, respectively;

FIG. 12 is a plot of luminous intensity vs. wavelength illustrating the results of a light emission wavelength of the quantum dots of Example 2;

FIG. 13 is a TEM image showing the shape and structure of the quantum, dots of Example 6;

FIG. 14 is a TEM image showing the shape and structure of the quantum dots of Example 7;

FIG. 15 is a TEM image showing the shape and structure of the quantum dots of Example 8;

FIG. 16 is a plot of luminous intensity vs. time illustrating light emission testing results for coated GaN chips of Examples 10 and 11 and Comparative Example;

FIG. 17 is a plot showing the measured intensities of first and second matrix layers of the wavelength converter of Example 12 using an LED light source having a peak, wavelength of about 450 nm;

FIG. 18 is a plot showing the measured intensities of the first and second matrix layers of the wavelength converter of Example 13 using an LED light source having a peak wavelength of about 450 nm;

FIG. 19 is a diagram showing a color gamut of the wavelength converter of Example 20; and

FIG. 20 is a diagram showing a color gamut of the wavelength converter of Example 21.

### DETAILED DESCRIPTION

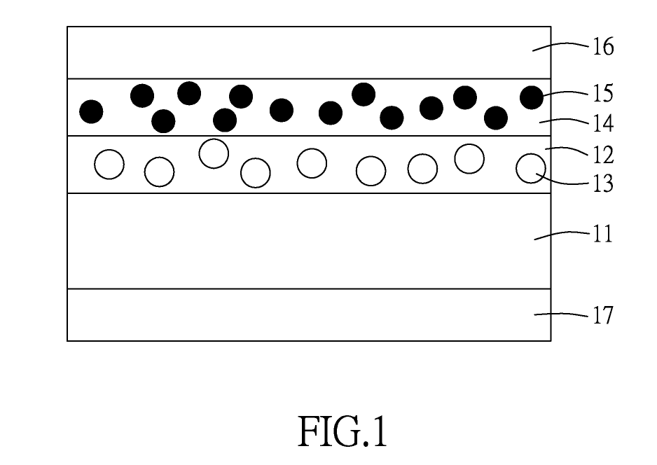

FIG. 1 illustrates the first embodiment of a quantum dot-containing wavelength converter according to the disclosure. The quantum dot-containing wavelength converter includes a transparent first substrate 11, a first matrix layer 12 of a first light transmissible material formed on and covering the first substrate 11, a plurality of first quantum dots 13 dispersed in the first matrix layer 12, a second matrix layer 14 of a second light transmissible material formed on and covering the first matrix layer 12, a plurality of second quantum dots 15 dispersed in the second matrix layer 14, a first barrier layer 16 formed on and covering the second matrix layer 16, and a second barrier layer 17 formed on and covering the first substrate 11. In this embodiment, the first and second matrix layers 12, 14 are stacked between the substrate 11 and the first barrier layer 16.

The first and second quantum dots 13, 15 have different energy band gaps. In this embodiment, the first and second quantum dots 13, 15 are made from the same material, but are different in size for converting a wavelength of a light source (not shown) into different wavelengths.

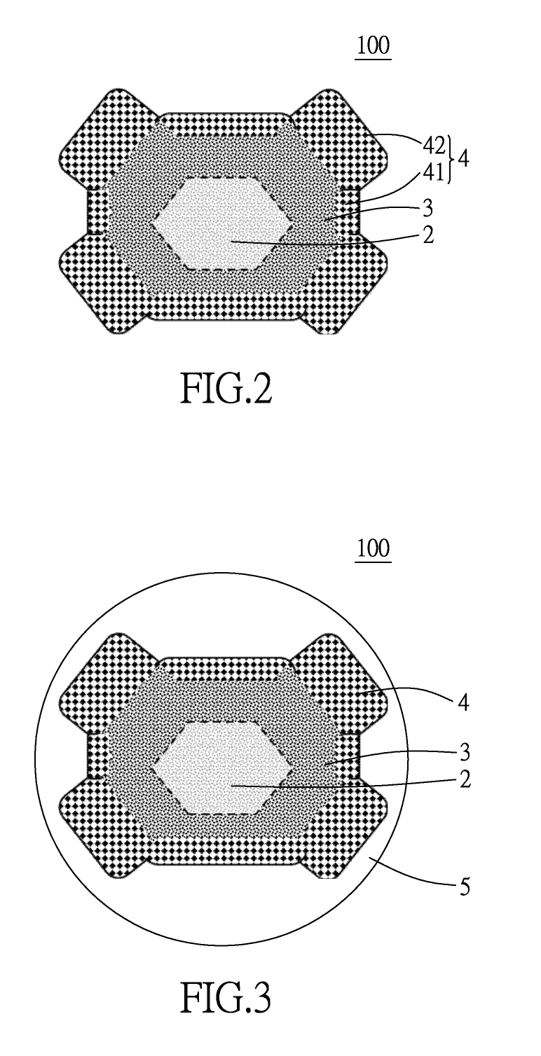

Each of the first and second quantum dots 13, 15 has a structure 100 (see FIG. 2) that includes a core 2 of a compound M1A1, an inner shell 3, and a multi-pod-structured outer shell 4 of a compound M1A2 or M2A2.

M1 of the compound M1A1 is a metal selected from the group consisting of Zn, Sn, Pb, Cd, In, Ga, Ge, Mn, Co, Fe, Al, Mg, Ca, Sr, Ba, Ni, Ag, Ti and Cu. A1 of the compound M1A1 is an element selected from, the group consisting of Se, S, Te, P, As, N, I, and O.

The inner shell 3 encloses the core 2, and has a composition containing a compound M1ₓM2₁₋ₓA1_{y}A2_{1-y}, wherein M2 is different from M1 and is a metal selected from the group consisting of Zn, Sn, Pb, Cd, In, Ga, Ge, Mn, Co, Fe, Al, Mg, Ca, Sr, Ba, Ni, Ag, Ti and Cu. A2 is different from A1 and is an element selected from the group consisting of Se, S, Te, P, As, N, I and O, 0<x≦1, 0<y<1, and y decreases over a layer thickness of the inner shell 3 in a direction from the core 2 toward the inner shell 3.

The multi-pod-structured outer shell 4 encloses the inner shell 3, and has a base portion 41 and a plurality of pod-like protrusion portions 42 that are spaced apart from one another and that extend from the base portion 41 in a direction away from the inner shell 3. The base portion 41 cooperates with the pod-like protrusion portions 42 to enclose entirely the inner shell 3. The multi-pod-structured outer shell 4 has the most stable morphology, and is grown in the thermodynamic equilibrium condition.

In certain embodiments, the number of the pod-like protrusion portions 42 may be greater than 2 and less than 10. In certain embodiments, the number of the pod-like protrusion portions 42 may range from 3 to 5.

In certain embodiments, the pod-like protrusion portions 42 and the base portion 41 may concurrently formed and shaped on the inner shell 3 through a thermally equilibrium process during crystal growth of the multi-pod-structured outer shell 4, which is different from conventional processes of growing on facets of crystal seeds of a core along specific directions. In certain embodiments, the multi-pod-structured outer shell 4 has a thermally equilibrium shape.

In certain embodiments, the multi-pod-structured outer shell 4 and the inner shell 3 may be concurrently formed through the thermally equilibrium process during crystal growth of the quantum dot.

Since the shape or structure of the multi-pod-structured outer shell 4 is formed through the thermally equilibrium process and since the pod-like protrusion portions 42 are interconnected through and are integrally formed with the base portion 41, the pod-like protrusion portions 42 may exhibit a relatively high mechanical strength on the inner shell 3, which may enhance the stability and quantum efficiency of the quantum dot.

In certain embodiments, x of the compound M1ₓM2₁₋ₓA1_{y}A2_{1-y} may vary over the layer thickness of the inner shell 3 when x is less than 1, M1 of the compound M1ₓM2₁₋ₓA1_{y}A2_{1-y} may be Zn, M2 of the compound M1ₓM2₁₋ₓA1_{y}A2_{1-y} may be Cd, Al of the compound M1ₓM2₁₋ₓA1_{y}A2_{1-y} may be Se, and A2 of the compound M1ₓM2₁₋ₓA1_{y}A2_{1-y} may be S.

In certain embodiments, M1 of the compound M1ₓM2₁₋ₓA1_{y}A2_{1-y} may be Cd, M2 of the compound M1ₓM2₁₋ₓA1_{y}A2_{1-y} may be Zn, A1 of the compound M1ₓM2₁₋ₓA1_{y}A2_{1-y} may be Se, and A2 of the compound M1ₓM2₁₋ₓA1_{y}A2_{1-y} may be S.

In certain embodiments, x of the compound M1ₓM2₁₋ₓA1_{y}A2_{1-y} is equal to 1, M1 of the compound M1ₓM2₁₋ₓA1_{y}A2_{1-y} is Zn, A1 of the compound M1ₓM2₁₋ₓA1_{y}A2_{1-y} may be Se, and A2 of the compound M1ₓM2₁₋ₓA1_{y}A2_{1-y} may be S.

In certain embodiments, the compound M1ₓM2₁₋ₓA1_{y}A2_{1-y} is doped with an element A3 that is different from A1 and A2 and that is selected from, the group consisting of Se, S, Te, P, As, N, I and O. In certain embodiments, A3 may be I.

In certain embodiments, the first and second, light transmissible materials may be the same, and may be selected from the group consisting of poly(dimethylsiloxane), Polymethyl methacrylate (PMMA), polystyrene (PS), Polyethylene terephthalate (PET), Polycarbonate (PC), Cyclic olefin copolymer (COC), Cyclic block copolymers (CBC), SiᵤTiᵥO_{4-z} (STO, 0.01<x<0.99, 0.01<v<0.99, −2<z<2), silicone, polylactic acid, polyimide, and combinations thereof.

In certain embodiments, each of the first and second barrier layers 16, 17 may be made from a composition containing a material that is selected from the group consisting of an organic-inorganic oxide hybrid polymer, ethylene-vinyl acetate (EVA), polyethylene, polypropylene, polystyrene, polyvinyl chloride, thermoplastic rubber, thermoplastic elastomer, silicone, epoxy, methyl methacrylate (MMA), polymethyl methacrylate (PMMA), and TiO₂. In certain embodiments, the inorganic-organic oxide polymer has a formula of SiᵤTiᵥO_{4-z}-OG (STO-OG), wherein 0.01<u<0.99, 0.01<v<0.99, −2<z<2, and OG represents organic molecules. In certain embodiments, OG is 2,4-pentanedione. The organic-inorganic oxide hybrid polymer (STO-OG polymer) has a structure that includes a STO porous matrix (not shown) and the organic molecules filling in pores in the STO porous matrix.

In certain embodiment, at least one the first and second barrier layers 16, 17 is made from the composition containing the organic-inorganic oxide hybrid polymer. In certain embodiment, at least one the first and second barrier layers 16, 17 is made from ethylene-vinyl acetate (EVA). In certain embodiment, at least one the first and second barrier layers 16, 17 is made from TiO₂.

In certain embodiments, the first substrate 11 may be made from a material selected from the group consisting of glass, polyethylene terephthalate, methyl methacrylate, and polymethyl methacrylate.

The first and second quantum dots 13, 15 may be used in a light emitting device, such that in certain embodiments, the inclusion of M2 in the inner shell 3 may control the light emission wavelength (the peak wavelength) of the light emitting device. In certain embodiments, the peak wavelength of the first and second quantum dots 13, 15 may vary from about 550 nm to about 650 nm in accordance with the concentration of M2, such as Cd, in the inner shell 3.

In certain embodiments, the first quantum dots 13 have a particle size ranging from 0.5 to 30 nm, while the second quantum dots 15 have a particle size ranging from 0.5 to 20 nm. In certain embodiments, the first quantum dots 13 have a particle size ranging from 0.5 to 30 nm, while the second quantum, dots 15 have a particle size ranging from 0.5 to 10 nm.

The first embodiment of the quantum dot-containing wavelength converter may be prepared by a method including the following consecutive steps of: dissolving polydimethylsiloxane (PDMS) in a first solvent to prepare a first PDMS solution; adding the first quantum dots 13 into the first PDMS solution to form a first coating; applying the first coating to the first substrate 11 to form the first matrix layer 12 on the first substrate 11; dissolving PDMS in a second solvent to prepare a second PDMS solution; adding the second quantum dots 15 into the second PDMS solution to form a second coating; applying the second coating to the first matrix layer 12 to form the second matrix layer 14 on the first matrix layer 12; preparing an STO-OG coating material; and applying the STO-OG coating material to the second matrix layer 14 and the first substrate 11 and curing the applied STO-OG coating materials so as to form the first barrier layer 16 on the second matrix layer 14 and the second barrier layer 17 on the first substrate 11.

Examples of the solvent employed to dissolve PDMS in the method may include hexane, toluene, chloroform, octane, mesithylene, decane, p-xylene, n,n-dimethylaniline, heptane, pentane, cyclohexane, methyl t-butyl ether, chlorobenzene, cyclopentane, and alcohols.

FIG. 3 illustrates a structure 100 of each of the first and second quantum dots 13, 15 of the second embodiment of the quantum dot-containing wavelength converter according to the disclosure.

The second embodiment differs from the previous embodiment in that the structure of each of the first and second quantum dots 13, 15 of the second embodiment further includes a cover layer 5 of an organic-inorganic oxide hybrid polymer that covers the multi-pod-structured outer shell 4. In certain embodiments, the organic-inorganic oxide hybrid polymer is STO-OG.

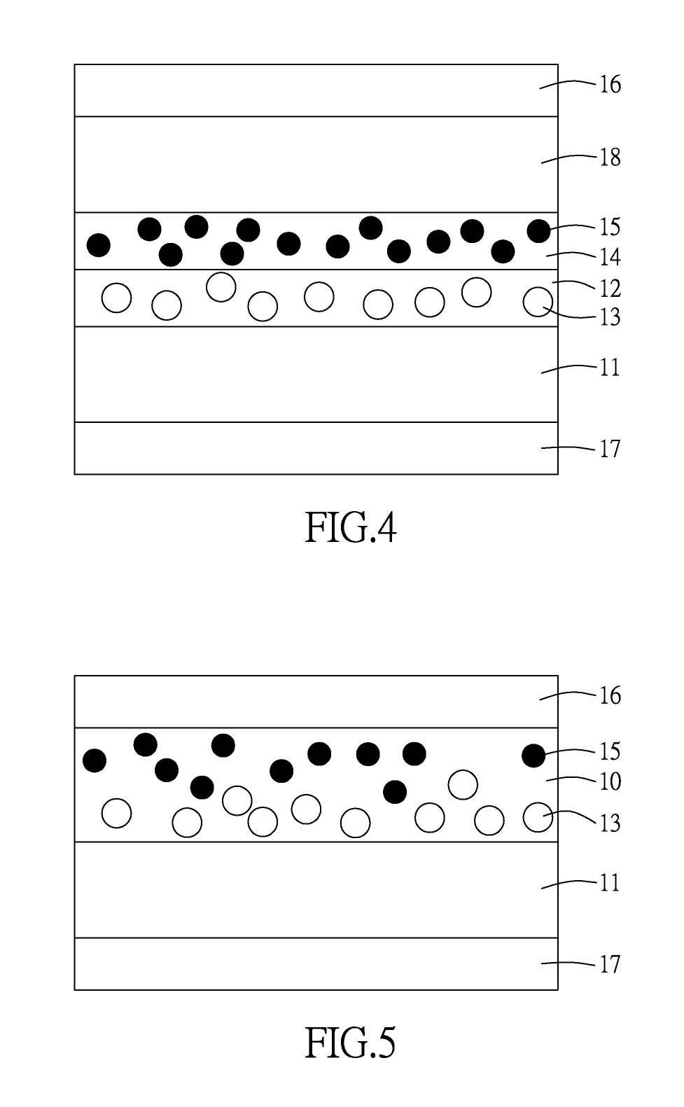

FIG. 4 illustrates the third embodiment of the quantum dot-containing wavelength converter according to the disclosure.

The third embodiment differs from the first embodiment in that the former further includes a transparent second substrate 18 and that the first barrier layer 16 is formed on and covers the second substrate 18. In this embodiment, the first and second matrix layers 12, 14 are respectively formed on and stacked between the first and second substrates 11, 18, and the first and second substrates 11, 18 are stacked between the first and second barrier layers 16, 17.

FIG. 5 illustrates the fourth embodiment of the quantum dot-containing wavelength converter according to the disclosure.

The fourth embodiment differs from the first embodiment in that the first and second quantum dots 13, 15 of the former are dispersed in the same matrix layer 10 of a light transmissible material in a grading dispersion manner.

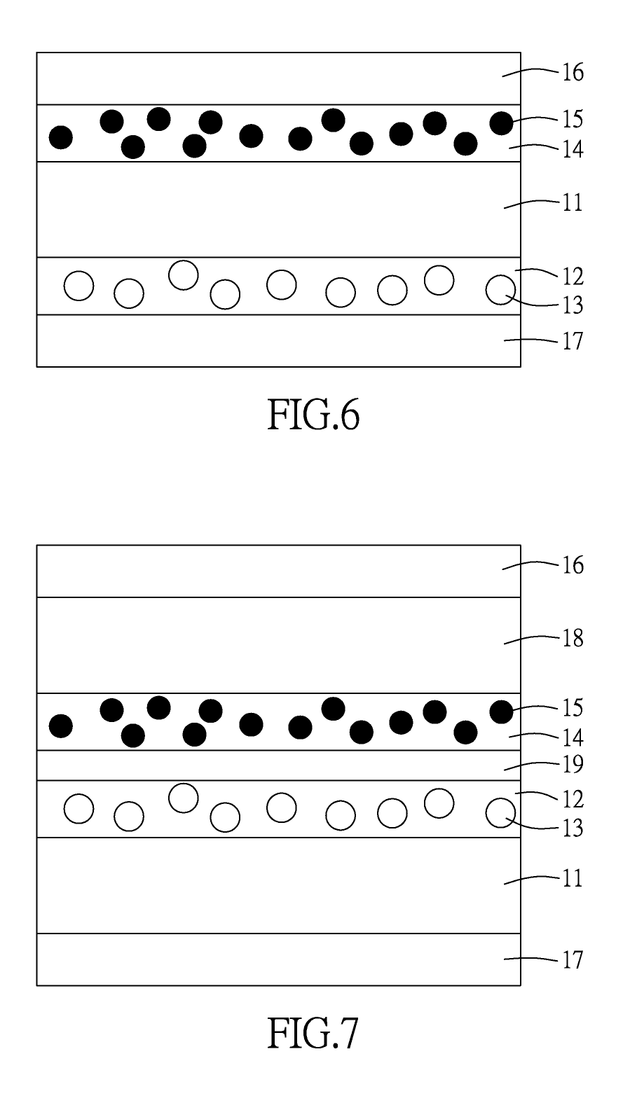

FIG. 6 illustrates the fifth embodiment of the quantum dot-containing wavelength converter according to the disclosure.

The fifth embodiment differs from the first embodiment in that the first substrate 11 is disposed between the first and second matrix layers 12, 14 and that the second barrier layer 17 is formed on and covers the first matrix layer.

FIG. 7 illustrates the sixth embodiment of the quantum dot-containing wavelength converter according to the disclosure.

The sixth embodiment differs from the third embodiment in that the former further includes an adhesive layer 19 that is disposed between and bonded to the first and second matrix layers 12, 14. The adhesive layer 19 may be made from STO.

The following Examples and Comparative Example are provided to illustrate the embodiments of the disclosure, and should not be construed as limiting the scope of the disclosure.

### EXAMPLE 1

<Preparation of Zn and Cd Precursors>

0.27 g CdO and 7.39 g zinc acetate anhydrous were added into a three neck round-bottom flask. The mixture was degassed under 100 mTorr for 120 minutes. 10 g trioctylphosphine (TOP), 24.68 g oleic acid and 116.7 g 1-octadecene (ODE) were added into the three neck round-bottom flask to form a Zn—Cd-containing precursor, followed by purging the three neck round-bottom flask with a nitrogen gas.

<Preparation of a Mixture of Se and S Precursors>

20 ml ODE and 0.74 g sulfur powder were mixed under room temperature to form a sulfur precursor (ODES). 20 ml TOP and 0.79 g selenium powder were mixed under room temperature to form a selenium precursor (TOPSe). The sulfur precursor and the selenium precursor were mixed in a flask to form a Se—S-containing precursor. The flask was purged with a nitrogen gas.

<Preparation of ZnSe/ZnₓCd₁₋ₓSe_{y}S_{1-y}/ZnS Quantum Dot>

The Zn—Cd-containing precursor in the three neck round-bottom flask was heated to 260° C., followed by injecting about one fifth (⅕) to about one third (⅓) of the Se—S-containing precursor into the three neck round-bottom flask to allow a first stage reaction between the Zn—Cd-containing precursor and the Se—S-containing precursor to occur for one minute, heating the mixture to 320° C. to allow a second stage reaction to occur for three minutes, and then repeating the injection (in an amount of about one fifth to about one third) and the first and second stage reactions until the prepared Se—S-containing precursor ran out (it is noted that the injection amount of the Se—S-containing precursor at each stage may vary according to actual requirements for controlling the position of the dopant (i.e., Cd) in the crystalline structure of the quantum dot. After the reaction, the mixture was cooled to 160° C., and was remained at this temperature for one hour in order to reach thermodynamic equilibrium. The mixture was then further cooled, and was repeatedly washed with a mixture of 50 ml toluene and 50 ml ethanol so as to obtain a powder of the quantum dot of Example 1 (the powder may be stored in a toluene solution).

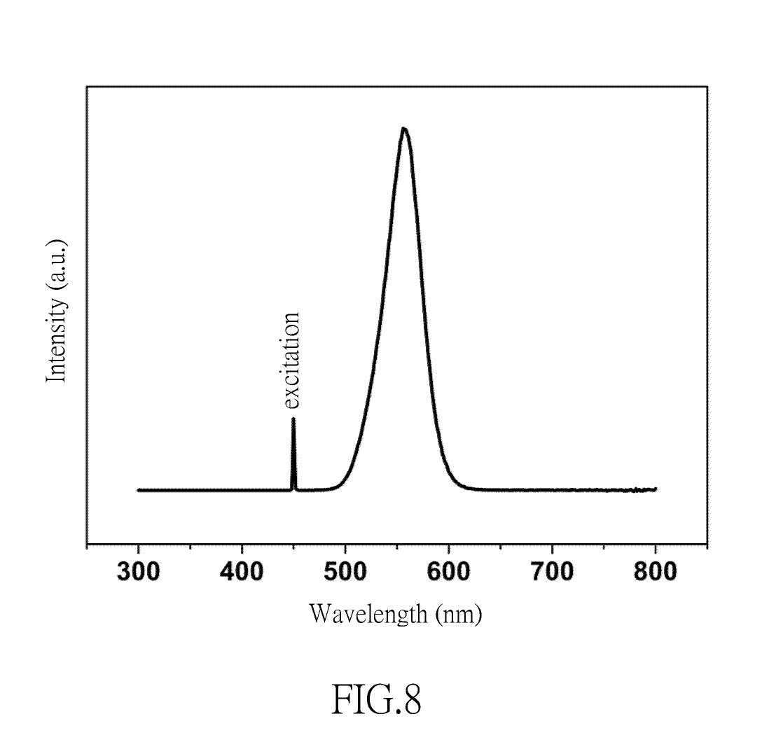

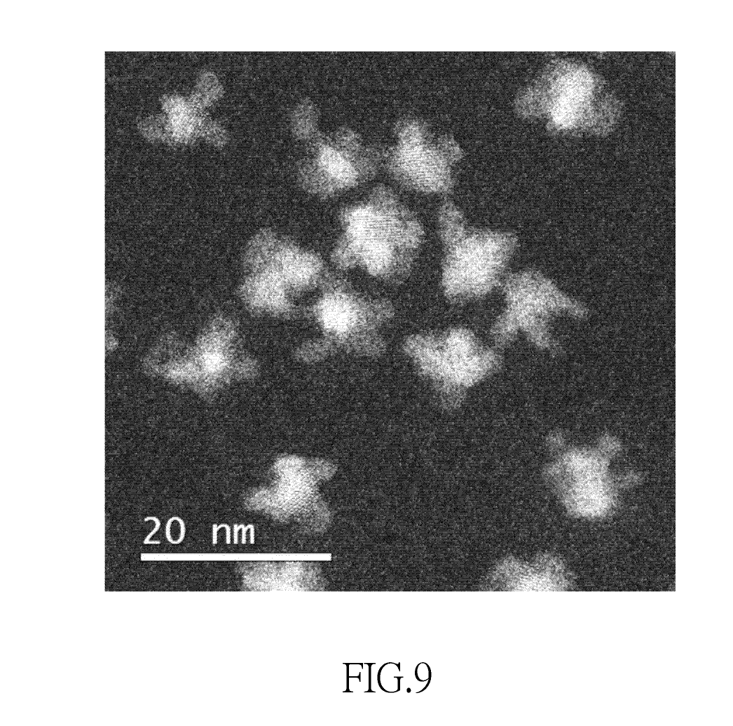

The quantum dot of Example 1 exhibited a peak wavelength of about 555 nm when subjected to a light emission test (see FIG. 8). In the light emission test, the quantum dots of Example 1 were dispersed in a silicone matrix layer to form a light conversion film, followed by passing a light source (having a wavelength of about 450 nm) emitted from a GaN LED chip through the light conversion film for converting the light source.

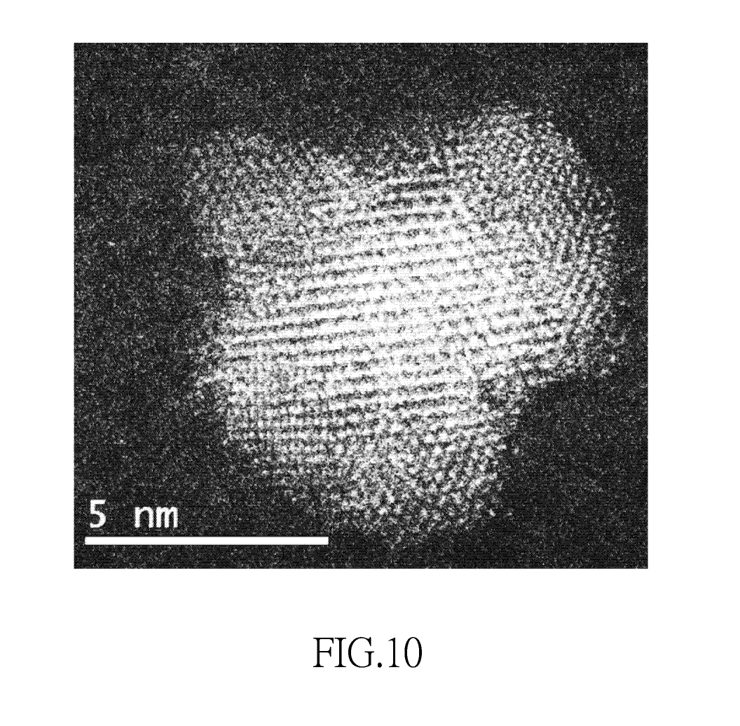

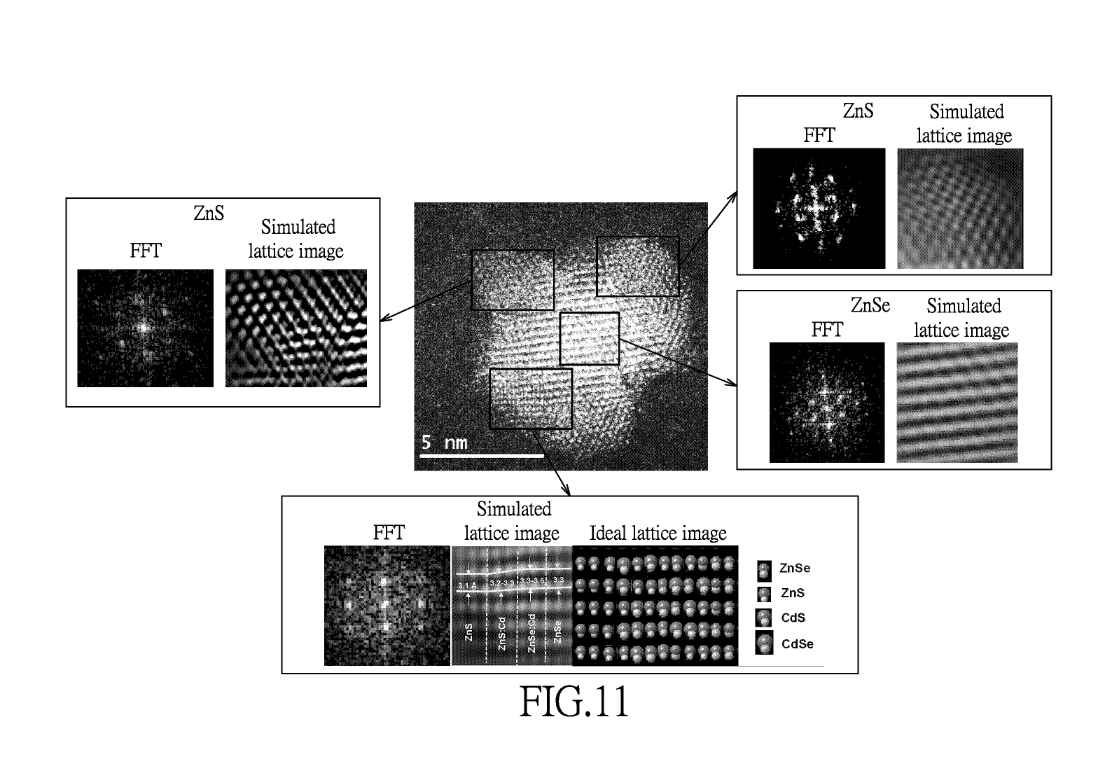

FIGS. 9 and 10 are TEM images showing the shape and structure of the quantum dots of Example 1. FIG. 11 is a TEM image of the quantum dot of Example 1 accompanied with inserted FFT (Fourier Transform) images and simulated lattice images that illustrate the structures of different zones of the quantum dot of Example 1, respectively.

### EXAMPLE 2

The procedures and the operating conditions of preparing the quantum dots of Example 2 were similar to those of Example 1, except that the amount of CdO employed in Example 2 was 0.2 g and that the first and second stage reactions lasted for 30 seconds and one minute, respectively.

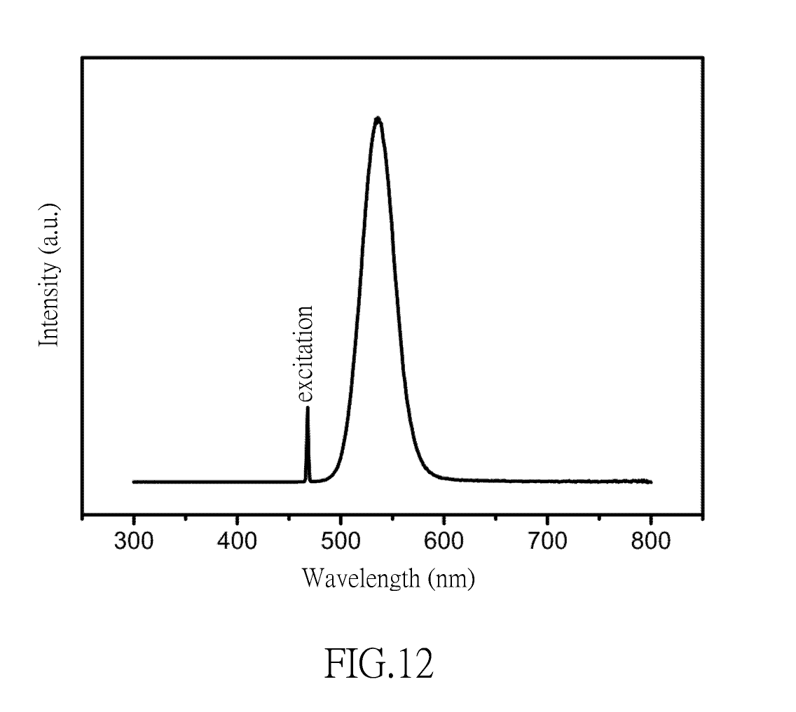

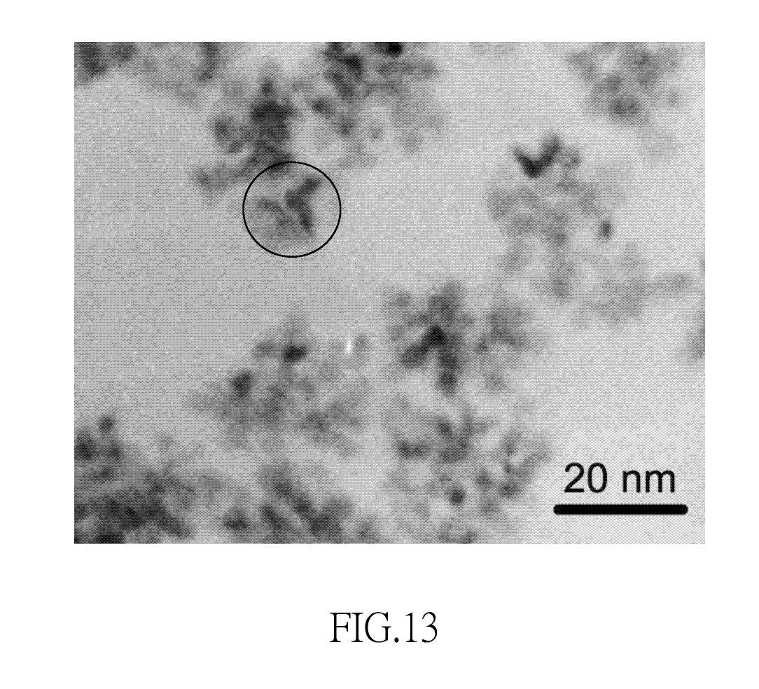

The quantum dots of Example 2 exhibited a peak wavelength of 536 nm (see FIG. 12) when subjected to the light emission wavelength test using a light source having a wavelength of about 470 nm.

### EXAMPLE 3

The procedures and the operating conditions of preparing the quantum dots of Example 3 were similar to those of Example 1, except that the amount of CdO employed in Example 3 was 0.3 g and that the second stage reaction lasted for five minutes.

The quantum dots of Example 3 exhibited a peak wavelength of 575 nm when subjected to the light emission wavelength test using a light source having a wavelength of about 450 nm.

### EXAMPLE 4

The procedures and the operating conditions of preparing the quantum dots of Example 4 were similar to those of Example 1, except that the amount of CdO employed in Example 4 was 0.5 g and that the second stage reaction lasted for five minutes.

The quantum dots of Example 4 exhibited a peak wavelength of 590 nm when subjected to the light emission wavelength test using a light source having a wavelength of about 450 nm.

### EXAMPLE 5

The procedures and the operating conditions of preparing the quantum dots of Example 5 were similar to those of Example 1, except that the amount of CdO employed in Example 5 was 1 g and that the first and second stage reactions lasted for 3 minutes and fifteen minutes, respectively.

The quantum dots of Example 5 exhibited a peak wavelength of 650 nm when subjected to the light emission wavelength test using a light source having a wavelength of about 450 nm.

### EXAMPLE 6

<Preparation of Zn Precursors>

5 mmol of zinc oxide were added into a three neck round-bottom flask. The mixture was degassed under 100 mTorr for 120 minutes. 5 g lauric acid and 1.93 g hexadecylamine were added into the three neck round-bottom flask to form a Zn-containing precursor, followed by purging the three neck round-bottom flask with a nitrogen gas.

<Preparation of a Mixture of Se and S Precursors>

5 ml TOP and 0.35 g sulfur powder were mixed under room temperature to form a sulfur precursor (TOPS). 2.5 ml TOP and 0.7 g selenium powder were mixed under room temperature to form a selenium precursor (TOPSe). The sulfur precursor and the selenium precursor were mixed in a flask to form a Se—S-containing precursor. The flask was purged with a nitrogen gas.

<Preparation of ZnSe/ZnSe_{y}S_{1-y}/ZnS Quantum Dot>

The Zn-containing precursor in the three neck round-bottom flask was heated to 300° C., followed by injecting about one fifth to about one third of the Se—S-containing precursor into the three neck round-bottom flask to allow a first stage reaction between the Zn-containing precursor and the Se—S-containing precursor to occur for one minute, maintaining the mixture at 280° C. to allow a second stage reaction to occur for three minutes, and then repeating the injection (in an amount of about one fifth to about one third for the first stage reaction) and the first and second stage reactions until the prepared Se—S-containing precursor ran out. After the reaction, the mixture was cooled to 160° C., and was remained at this temperature for one hour. The mixture was then further cooled, and was repeatedly washed with a mixture of 50 ml toluene and 50 ml ethanol so as to obtain a powder of the quantum dot of Example 6.

FIG. 13 is a TEM image showing the shape and structure of the quantum dots of Example 6.

### EXAMPLE 7

<Preparation of Zn Precursors>

0.41 g zinc oxide anhydrous were added into a three neck round-bottom flask. The mixture was degassed under 100 mTorr for 120 minutes. 1.6 g lauric acid and 1.93 g hexadecylamine, were added into the three neck round-bottom flask to form a Zn-containing precursor, followed by purging the three neck round-bottom flask with a nitrogen gas.

<Preparation of a Mixture of Se, S and I Precursors>

2 ml TOP and 0.12 g sulfur powder were mixed under room temperature to form a sulfur precursor TOPS. 1 ml TOP and 0.12 g selenium powder were mixed under room temperature to form a selenium precursor (TOPSe). 1 ml TOP, 0.012 g iodine and 0.12 g Se powder were mixed to form an iodine-containing precursor. The sulfur precursor, the iodine-containing precursor and the selenium precursor were mixed in a flask to form a Se—S—I-containing precursor. The flask was purged with a nitrogen gas.

<Preparation of ZnSe/ZnSe_{y}S_{1-y}:I/ZnS Quantum Dot>

The Zn-containing precursor in the three neck round-bottom flask was heated to 280° C., followed by injecting about one fifth to about one third of the Se—S-containing precursor into the three neck round-bottom flask to allow a first stage reaction between the Zn-containing precursor and the Se—S-containing precursor to occur for one minute, maintaining the mixture at 260° C. to allow a second stage reaction to occur for three minutes, and then repeating the injection (in an amount of about one fifth to about one third for the first stage reaction) and the first and second stage reactions until the prepared Se—S-containing precursor ran out. After the reaction, the mixture was cooled to 150° C., and was remained at this temperature for one hour. The mixture was then further cooled, and was repeatedly washed with a mixture of 50 ml toluene and 50 ml ethanol so as to obtain a powder of the quantum dot of Example 7.

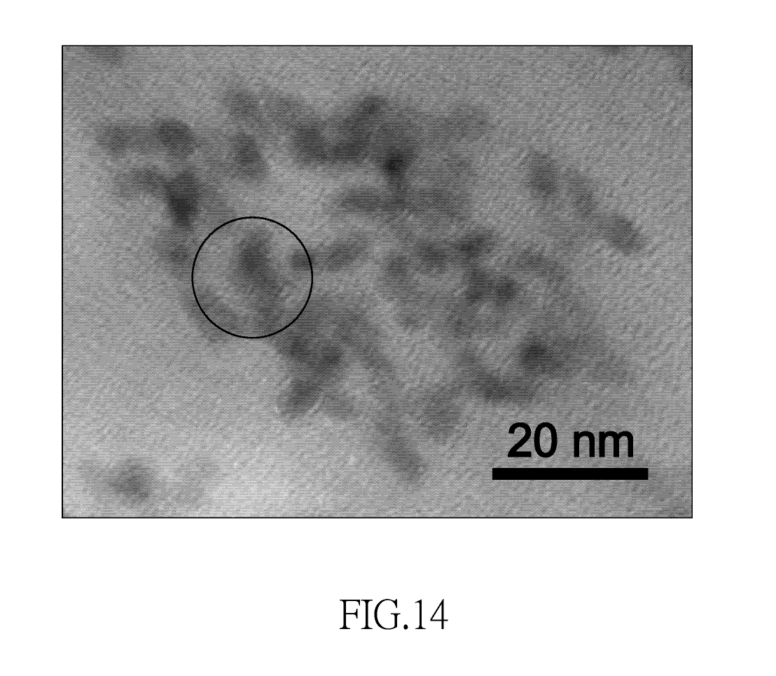

FIG. 14 is a TEM image showing the shape and structure of the quantum dots of Example 7.

### EXAMPLE 8

<Preparation of Cd and Zn Precursors>

7.39 g CdO and 0.27 g zinc acetate anhydrous were added into a three neck round-bottom flask. The mixture was degassed under 100 mTorr for 120 minutes. 10 g trioctylphosphine (TOP), 24.68 g oleic acid and 116.7 g 1-octadecene (ODE) were added into the three neck round-bottom flask to form a Zn—Cd-containing precursor, followed by purging the three neck round-bottom flask with a nitrogen gas.

<Preparation of a Mixture of Se and S Precursors>

20 ml ODE and 0.74 g sulfur powder were mixed under room temperature to form a sulfur precursor (ODES). 20 ml TOP and 0.79 g selenium powder were mixed under room temperature to form a selenium precursor (TOPSe). The sulfur precursor and the selenium precursor were mixed in a flask to form a Se—S-containing precursor. The flask was purged with a nitrogen gas.

<Preparation of CdSe/CdₓZn₁₋ₓSe_{y}S_{1-y}/ZnS Quantum Dot>

The Zn—Cd-containing precursor in the three neck round-bottom flask was heated to 260° C., followed by injecting about one fifth to about one third of the Se—S-containing precursor into the three neck round-bottom flask to allow a first stage reaction between the Zn—Cd-containing precursor and the Se—S-containing precursor to occur for one minute, heating the mixture to 320° C. to allow a second stage reaction to occur for three minutes, and then repeating the injection (in an amount of about one fifth to about one third) and the first and second stage reactions until the prepared Se—S-containing precursor ran out. After the reaction, the mixture was cooled to 160° C., and was remained at this temperature for one hour. The mixture was then further cooled, and was repeatedly washed with a mixture of 50 ml toluene and 50 ml ethanol so as to obtain a powder of the quantum dot of Example 8.

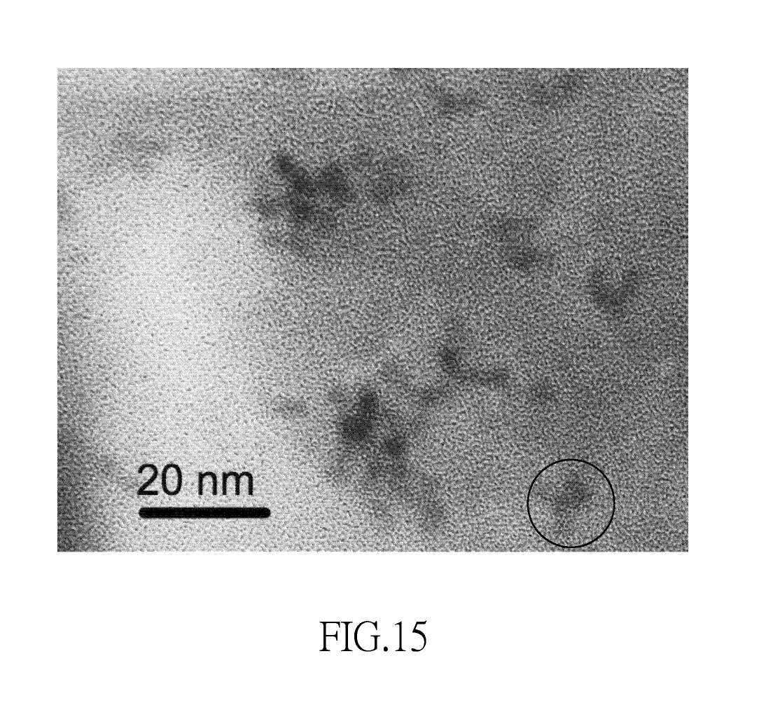

FIG. 15 is a TEM image showing the shape and structure of the quantum dots of Example 8.

### EXAMPLE 9

<Preparation of SiᵤTiᵥO_{4-z}/Pentanedione Hybrid Polymer (STO-OG)>

3.1 mmol titanium isopropoxide (TTIP), 33.1 mmol 1-propanol and 3 mmol acetylacetone (ACAC) were mixed together to form a titania precursor. 8.6 mmol tetraethoxysilane (TEOS) and 103.2 mmol ethanol were mixed together to form a silica precursor. The titania precursor and the silica precursor were mixed together, followed by mixing the mixture with deionized water to allow simultaneous hydrolysis and condensation to occur. The mixture was continuously stirred and was subjected to polymerization under room temperature for 48 hours so as to obtain a STO-OG gel.

<Preparation of STO-OG/ZnSe/ZnₓCd₁₋ₓSe_{y}S_{1-y}/ZnS Quantum Dot>

1 ml STO-OG gel thus obtained, 10 mg of the powder of the quantum dot of Example 1 and 1 ml toluene were mixed with stirring for 6 hours, followed by filtration using a centrifugal filter to obtain a precipitate. The precipitate was dissolved in a toluene solution with stirring for about 24 hours to 72 hours to obtain a STO-OG layer wrapped quantum dot. The STO-OG layer thus formed had a layer thickness of about 2 nm to 3 nm. The STO-OG layer was modified by mixing with 1 mg chlorotrimethylsilane (TMCS) with stirring for 12 hours. The modification of the STO-OG layer is to change the polarity of the STO-OG layer, so that the modified STO-OG layer can be dissolved in a non-polar solvent.

### EXAMPLE 10

<Preparation of GaN Chip Having Quantum Dots of Example 1>

The quantum dots of Example 1 were mixed with a polymer solution containing poly(dimethylsiloxane) (PDMS) and toluene to form a mixture. The mixture was applied to a GaN chip to form a wavelength conversion layer on the GaN chip.

### EXAMPLE 11

<Preparation of GaN Chip Having Quantum Dots of Example 2>

The quantum dots of Example 2 were mixed with a solution containing the STO-OG of Example 9 and toluene to form a mixture. The mixture was applied to a GaN chip to form a wavelength conversion layer on the GaN chip.

### COMPARATIVE EXAMPLE

<Preparation of GaN Chip Having Quantum Dots of the Prior Art>

The quantum dots of the prior art having a structure of CdSe (core)/ZnS (shell) were mixed with a polymer solution containing PDMS and toluene to form a mixture, followed by applying the mixture to a GaN chip to form a wavelength conversion layer on the GaN chip.

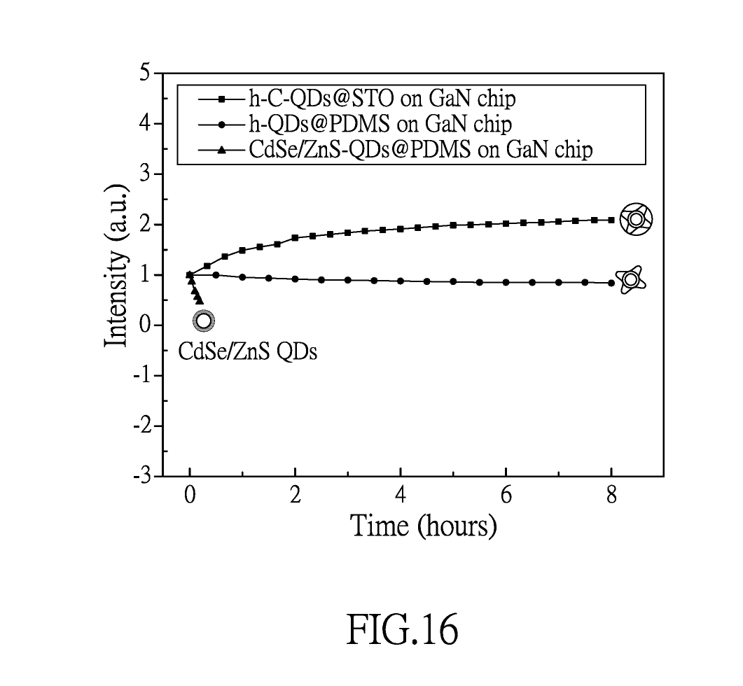

FIG. 16 is a plot of luminous intensity vs time illustrating light emission testing results for the coated GaN chips of Examples 10 and 11 and Comparative Example. The results show that the coated GaN chip of the prior art has a 15% decay in the luminous intensity after about 30 minutes, while the coated GaN chip of Example 10 has a 15% decay in the luminous intensity after 8 hours and the coated GaN chip of Example 11 shows no sign of decay in the luminous intensity after 8 hours.

### EXAMPLE 12

<Preparation of the Wavelength Converter>

2.75 ml of a first quantum dot-containing solution was mixed with a cross-linkable bi-component silicone material with stirring to allow uniform cross-linking of the bi-component silicone material. The first quantum dot-containing solution contained hexane and quantum dots with a peak wavelength of 535 nm (referred herein to as 535 nm-QD particles), and had a QD concentration of 5 mg/ml. The procedures and the operating conditions of preparing the 535 nm-QD particles were approximately similar to those of Example 1 (the wavelength of the QDs depending on the grown particle size of the QDs). The bi-component silicone material contained 2.5 g PDMS part A and 0.25 g PDMS part B. The mixture was subjected to degassing during and after the cross-linking reaction for about 20 minutes so as to form a 535 nm-QD film-forming precursor.

2.75 ml of a second quantum dot-containing solution was mixed with the bi-component silicone material with stirring to allow uniform cross-linking of the bi-component silicone material. The second quantum dot-containing solution contained hexane and quantum dots with a peak wavelength of 620 nm (referred herein to as 620 nm-QD particles), and had a QD concentration of 5 mg/ml. The procedures and the operating conditions of preparing the 620 nm-QD particles were approximately similar to those of Example 1. The bi-component silicone material contained 2.5 g PDMS part A and 0.25 g PDMS part B. The mixture was subjecting to degassing during and after the cross-linking reaction for about 20 minutes so as to form a 620 nm-QD film-forming precursor.

A first PET substrate was placed in a mold. The 620 nm-QD film-forming precursor thus formed was poured into the mold to cover the first PET substrate, followed, by degassing for about 20 minutes and drying under 120° C. for 18 minutes so as to form a first matrix layer with the 620 nm-QD particles embedded therein on the first PET substrate (the drying was controlled in such a manner that the first matrix layer thus formed was not completely dried). The 535 nm-QD film-forming precursor thus formed was subsequently poured into the mold to cover the first matrix layer, followed by degassing and drying under 120° C. for 18 minutes so as to form a second matrix layer with the 535 nm-QD particles embedded therein on the first matrix layer. A second PET substrate was placed in the mold to cover the second matrix layer, followed by drying under 120° C. for 10 minutes so as to form a layer stack including the first and second PET substrates, the second matrix layer and the first matrix layer. The layer stack was subjected to O₂ plasma treatment under a power of 70 W, followed by applying a STO-OG gel on the second PET substrate and drying under 100° C. for one hour so as to form a STO-OG barrier layer on the second PET substrate. The procedures and conditions of preparing the STO-OG gel were approximately similar to those of Example 9.

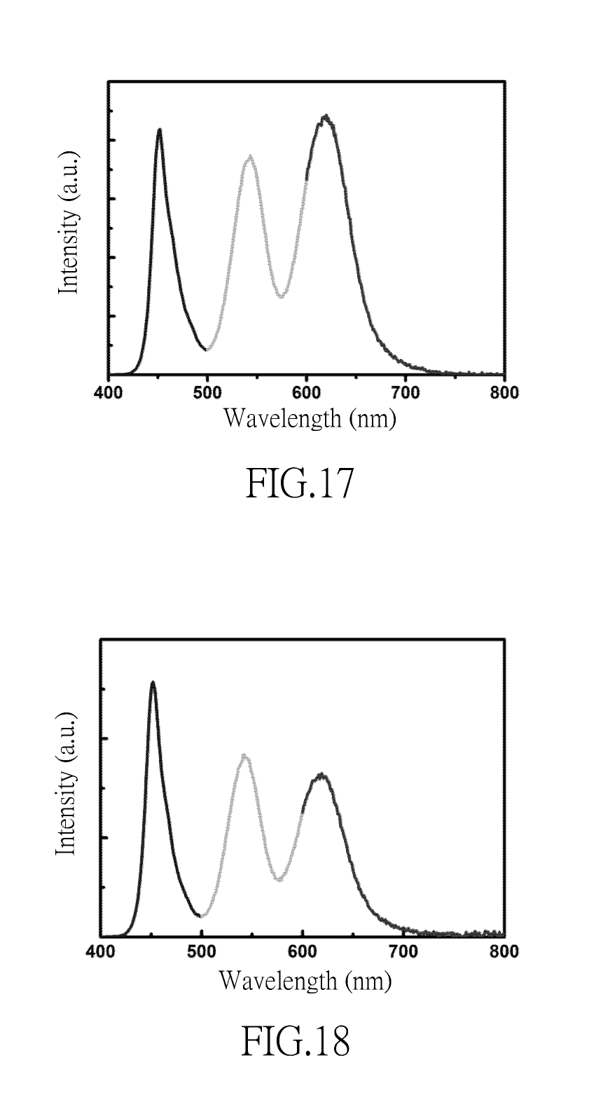

The wavelength converter thus formed has a color-rendering index (CRI) of 89 and CIE tristimulus values of (0.39, 0.36, 0.25) in the CIE XYZ color space. FIG. 17 shows the measured intensities of the first matrix layer and the second matrix layer using an LED light source having a peak wavelength of about 450 nm.

### EXAMPLE 13

<Preparation of the Wavelength Converter>

The procedures and conditions of preparing the wavelength converter of Example 13 were similar to those of Example 12, except that the first quantum dot-containing solution contained quantum dots with a peak wavelength of 550 nm (referred herein to as 550 nm-QD particles), that the 620 nm-QD film-forming precursor applied to the first PET substrate was dried under 120° C. for 10 minutes (instead of 18 minutes in Example 12) so as to form a half-dried 620 nm-QD embedded layer on the first PET substrate, and that the 550 nm-QD film-forming precursor was subsequently applied to the half dried 620 nm-QD embedded layer so as to permit penetration of the 550 nm-QD particles into the half-dried 620 nm-QD embedded layer and to form a graded concentration of the 550 nm-QD particles in the half-dried 620 nm-QD embedded layer.

The wavelength converter thus formed has a color-rendering index (CRT) of 88 and CIE tristimulus values of (0.36, 0.34, 0.31) in the CIE XYZ color space. FIG. 18 shows the measured intensities of the first matrix layer and the second matrix layer using an LED light source having a peak wavelength of about 450 nm.

### EXAMPLE 14

<Preparation of the Wavelength Converter>

2.58 ml of a first quantum dot-containing solution and 0.17 ml of a second quantum dot-containing solution was mixed with a cross-linkable bi-component silicone material with stirring to allow uniform cross-linking of the bi-component silicone material. The first and second quantum dot-containing solutions and the bi-component silicone material employed in Example 14 were the same as those of Example 12, respectively. The mixture was subjected to degassing during and after the cross-linking reaction for about 20 minutes so as to form a mixed-QD film-forming precursor.

A first PET substrate was placed in a mold. The mixed-QD film-forming precursor thus formed was poured into the mold to cover the first PET substrate, followed by degassing for about 20 minutes and drying under 120° C. for 18 minutes so as to form a matrix layer with the 550 nm-QD particles and the 620 nm-QD particles embedded therein on the first PET substrate. A second PET substrate was placed in the mold to cover the matrix layer, followed by drying under 120° C. for 10 minutes so as to form a layer stack including the first and second PET substrates and the matrix layer. The layer stack was subjected to O₂ plasma treatment under a power of 70 W, followed by applying a STO-OG gel on the second PET substrate and drying under 100° C. for one hour so as to form a STO-OG barrier layer on the second PET substrate. The procedures and conditions of preparing the STO-OG gel were approximately similar to those of Example 9. Unlike Example 13, the 550 nm-QD particles and the 620 nm-QD particles in the matrix layer are substantially well mixed throughout the entire thickness of the matrix layer.

### EXAMPLE 15

<Preparation of the Wavelength Converter>

The procedures and conditions of preparing the wavelength converter of Example 15 were similar to those of Example 12, except that only one PET substrate was employed and that the second matrix layer and the first matrix layer were formed on opposite sides of the PET substrate. In Example 15, the 620 nm-QD film-forming precursor was poured into the mold and was half dried before placement of the PET substrate in the mold.

### EXAMPLE 16

<Preparation of the Wavelength Converter>

The procedures and conditions of preparing the wavelength converter of Example 16 were similar to those of Example 12, except that a middle STO-OG layer was formed between the first matrix layer and the second matrix layer. In Example 16, the STO-OG gel was applied to the first matrix layer, followed by drying under 100° C. for one hour to form the middle STO-OG layer before pouring the 535 nm-QD film-forming precursor into the mold.

### EXAMPLE 17

<Preparation of the Wavelength Converter>

1 g PMMA was dissolved in 9.34 ml toluene to form a PMMA solution with stirring using supersonic vibrator. A first quantum dot-containing solution containing toluene and quantum dots with a peak wavelength of 550 nm (referred herein to as 550 nm-QD particles) and having a QD concentration of 10 mg/ml was prepared. The procedures and the operating conditions of preparing the 550 nm-QD particles were approximately similar to those of Example 1. 1 ml of the first quantum dot-containing solution was mixed with the PMMA solution with stirring so as to form a 550 nm-QD film-forming precursor.

1 g PMMA was dissolved in 9.34 ml toluene to form a PMMA solution with stirring using supersonic vibrator. A second quantum dot-containing solution containing toluene and quantum dots with a peak wavelength of 620 nm (referred herein to as 620 nm-QD particles) and having a QD concentration of 10 mg/ml was prepared. The procedures and the operating conditions of preparing the 620 nm-QD particles were approximately similar to those of Example 1. 1 ml of the second quantum dot-containing solution was mixed with the PMMA solution with stirring so as to form a 620 nm-QD film-forming precursor.

A PET substrate was placed in a mold. The 620 nm-QD film-forming precursor thus formed was poured into the mold to cover the PET substrate, followed by drying under 120° C. for 10 minutes so as to form a first matrix layer with the 620 nm-QD particles embedded therein on the PET substrate. The 550 nm-QD film-forming precursor thus formed was subsequently poured into the mold to cover the first matrix layer, followed by drying under 120° C. for 10 minutes so as to form a second matrix layer with the 550 nm-QD particles embedded therein on the first matrix layer. The assembly of the PET substrate, the first matrix layer and the second matrix layer was subjected to O₂ plasma treatment under a power of 70 W, followed by applying a STO-OG gel on the second matrix layer and drying under 100° C. for one hour so as to form a STO-OG barrier layer on the second matrix layer. The procedures and conditions of preparing the STO-OG gel were approximately similar to those of Example 9.

### EXAMPLE 18

<Preparation of the Wavelength Converter>

A STO-OG gel was prepared based on procedures and conditions approximately similar to those of Example 9. A first quantum dot-containing solution containing toluene and quantum dots with a peak wavelength of 535 nm (referred herein to as 535 nm-QD particles) and having a QD concentration of 10 mg/ml was prepared. The procedures and the operating conditions of preparing the 535 nm-QD particles were approximately similar to those of Example 1. 1 ml of the first quantum dot-containing solution was mixed with 1 ml of the STO-OG gel with stirring under room temperature for about 6 hours. The mixture was subsequently subjected to centrifugal filtration to obtain a precipitate of STO-OG wrapped 535 nm-QD beads. The precipitate was dispersed in a toluene solution with stirring for about 72 hours to reduce the size of the STO-OG wrapped 535 nm-QD beads, followed by filtration. Each of the STO-OG wrapped 535 nm-QD beads thus formed had a STO-OG cover layer (with a layer thickness of from 2 nm to 3 nm) enclosing three to five 535 nm-QD particles therein. The STO-OG wrapped 535 nm-QD beads were removed from the toluene solution, and were dispersed in a solution containing ethanol and the STO-OG gel so as to form a 535 nm-bead film-forming precursor.

A second quantum dot-containing solution containing toluene and quantum dots with a peak wavelength of 620 nm (referred herein to as 620 nm-QD particles) and having a QD concentration of 10 mg/ml was prepared. The procedures and the operating conditions of preparing the 620 nm-QD particles were approximately similar to those of Example 1. 1 ml of the second quantum dot-containing solution was mixed with 1 ml of the STO-OG gel with stirring under room temperature for about 6 hours to perform wrapping of the 620 nm-QD particles. The mixture was subsequently subjected to centrifugal filtration to obtain a precipitate of STO-OG wrapped 620 nm-QD beads. The precipitate was dispersed in a toluene solution with stirring for about 72 hours to reduce the size of the STO-OG wrapped 620 nm-QD beads, followed by filtration. Each of the STO-OG wrapped 620 nm-QD beads thus formed had a STO-OG cover layer (with a layer thickness of from 2 nm to 3 nm) enclosing three to five 620 nm-QD particles therein. The STO-OG wrapped 620 nm-QD beads were removed from the toluene solution, and were dispersed in a solution containing ethanol and the STO-OG gel so as to form a 620 nm-bead film-forming precursor.

The 620 nm-bead film-forming precursor was applied to a cleaned glass substrate, followed by drying under 100° C. for 30 minutes so as to form a first matrix layer with the STO-OG wrapped 620 nm-QD beads embedded therein. The 535 nm-bead film-forming precursor was applied to the first matrix layer, followed by drying under 100° C. for 30 minutes so as to form a second matrix layer with the STO-OG wrapped 535 nm-QD beads embedded therein on the first matrix layer.

### EXAMPLE 19

<Preparation of the Wavelength Converter>

The procedures and conditions of preparing the wavelength converter of Example 19 were similar to those of Example 18, except that the precipitate of the STO-OG wrapped 535 nm-QD beads was dispersed in the toluene solution with stirring for about 24 hours and that the precipitate of the STO-OG wrapped 620 nm-QD beads was dispersed in the toluene solution with stirring for about 24 hours. Each of the STO-OG wrapped 535 nm-QD beads thus formed had a STO-OG shell layer (with a layer thickness of from 2 nm to 3 nm) enclosing ten to fifty 535 nm-QD particles therein. Each of the STO-OG wrapped 620 nm-QD beads thus formed had a STO-OG shell layer (with a layer thickness of from 2 nm to 3 nm) enclosing ten to fifty 620 nm-QD particles therein.

### EXAMPLE 20

<Preparation of the Wavelength Converter>

2.58 ml of a first quantum dot-containing solution and 0.17 ml of a second quantum dot-containing solution were mixed with a cross-linkable bi-component silicone material with stirring to allow uniform cross-linking of the bi-component silicone material. The first quantum dot-containing solution contained hexane and quantum dots with a peak wavelength of 535 nm (referred herein to as 535 nm-QD particles), and had a QD concentration of 5 mg/ml. The second quantum dot-containing solution contained hexane and quantum dots with a peak wavelength of 615 nm (referred herein to as 615 nm-QD particles), and had a QD concentration of 5 mg/ml. The procedures and the operating conditions of preparing the 535 nm-QD and 615 nm-QD particles were approximately similar to those of Example 1. The bi-component silicone material contained 2.5 g PDMS part A and 0.25 g PDMS part B. The mixture was subjected to degassing during and after the cross-linking reaction for about 20 minutes so as to form a mixed-QD film-forming precursor.

The mixed-QD film-forming precursor was applied to a glass substrate, followed by degassing for about 20 minutes and drying under 120° C. for 20 minutes so as to form a matrix layer with the 535 nm-QD and 615 nm-QD particles embedded therein. A TiO₂ barrier layer was formed on the matrix layer using atomic layer deposition (ALD) techniques.

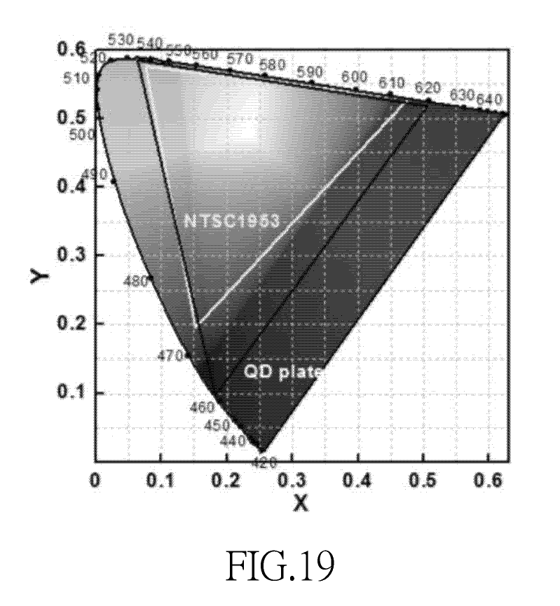

FIG. 19 shows a color gamut (the larger triangle indicated as the QD plate in FIG. 19) of the wavelength converter of Example 20. The smaller triangle indicated as the NTSC1953 in FIG. 19 represents the standard NTSC color gamut defined by National Television System Committee (NTSC).

### EXAMPLE 21

<Preparation of the Wavelength Converters>

The procedures and conditions of preparing the wavelength converter of Example 21 were similar to those of Example 20, except that 0.67 ml of the first quantum dot-containing solution, 0.067 ml of the second quantum dot-containing solution and 2.021 ml of a third quantum dot-containing solution were mixed with the cross-linkable bi-component silicone material. The third quantum dot-containing solution contained hexane and quantum dots with a peak wavelength of 480 nm (referred herein to as 480 nm-QD particles), and had a QD concentration of 5 mg/ml.

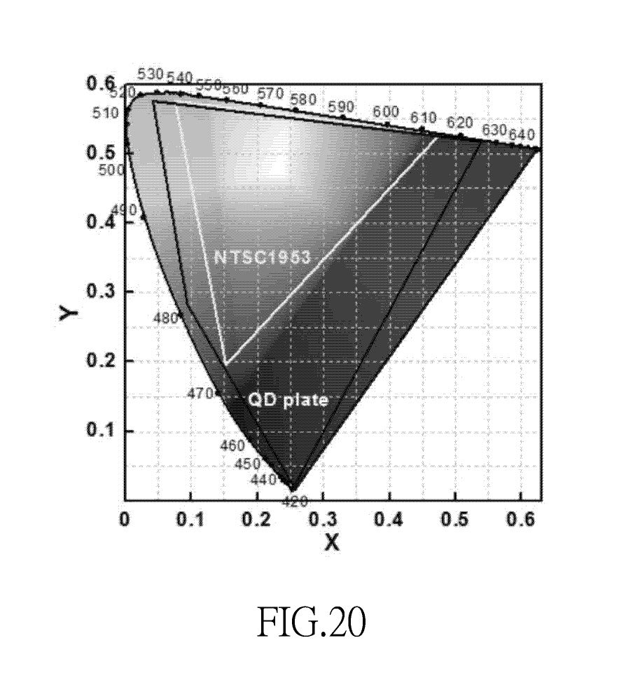

FIG. 20 shows a color gamut (the larger triangle indicated as the QD plate in FIG. 20) of the wavelength converter of Example 21. The smaller triangle indicated as the NTSC1953 in FIG. 20 represents the standard NTSC color gamut defined by National Television System Committee (NTSC).

With the inclusion of the multi-pod-structured outer shell 4 in the first and second quantum dots 13, 15 of the quantum dot-containing wavelength converter of the disclosure, at least one of the aforesaid drawbacks associated with the prior art may be alleviated.

While the disclosure has been described in connection with what are considered the exemplary embodiments, it is understood that the disclosure is not limited to the disclosed embodiments but is intended to cover various arrangements included within the spirit and scope of the broadest interpretation and equivalent arrangements.

What is claimed is:

1. A quantum dot-containing wavelength converter comprising:
a first matrix layer of a first light transmissible material; and
a plurality of first quantum dots dispersed in said first matrix layer, each of said first quantum dots including a core of a compound M1A1, an inner shell, and a multi-pod-structured outer shell of a compound M1A2 or M2A2;
wherein M1 is a metal selected from the group consisting of Zn, Sn, Pb, Cd, In, Ga, Ge, Mn, Co, Fe, Al, Mg, Ca, Sr, Ba, Ni, Ag, Ti and Cu, and A1 is an element selected from the group consisting of Se, S, Te, P, As, N, I, and O;
wherein said inner shell encloses said core and has a composition containing a compound M1ₓM2₁₋ₓA1_{y}A2_{1-y}, wherein M2 is different from M1 and is a metal selected from the group consisting of Zn, Sn, Pb, Cd, In, Ga, Ge, Mn, Co, Fe, Al, Mg, Ca, Sr, Ba, Ni, Ag, Ti and Cu, A2 is different from A1 and is an element selected from the group consisting of Se, S, Te, P, As, N, I and O, 0<x≦1, 0<y<1, and y decreases over a layer thickness of said inner shell in a direction from said core toward said inner shell; and
wherein said multi-pod-structured outer shell encloses said inner shell and has a base portion and a plurality of protrusion portions that are spaced apart from one another and that extend from said base portion in a direction away from said inner shell.

2. The quantum dot-containing wavelength converter of claim 1, wherein said first light transmissible material is selected from the group consisting of poly(dimethylsiloxane), Polymethyl methacrylate, polystyrene, Polyethylene terephthalate, Polycarbonate, Cyclic olefin copolymer, Cyclic block copolymers, SiᵤTiᵥO_{4-z}, silicone, polylactic acid, polyimide, and combinations thereof, wherein 0.01<u<0.99, 0.01<v<0.99, −2<z<2.

3. The quantum dot-containing wavelength converter of claim 1, further comprising a first barrier layer covering said first matrix layer and made from a composition containing an organic-inorganic oxide hybrid polymer.

4. The quantum dot-containing wavelength converter of claim 3, wherein said inorganic-organic oxide polymer has a formula of SiᵤTiᵥO_{4-z}/OG, wherein 0.01<u<0.99, 0.01<v<0.99, −2<z<2, and OG represents organic molecules.

5. The quantum dot-containing wavelength converter of claim 1, further comprising a second matrix layer of a second light transmissible material and a plurality of second quantum dots dispersed in said second matrix layer, said second matrix layer being disposed on said first matrix layer, said first and second quantum dots having different energy band gaps.

6. The quantum dot-containing wavelength converter of claim 5, further comprising transparent first and second substrates, said first and second matrix layers being respectively formed on said first and second substrates and being stacked between said first and second substrates.

7. The quantum dot-containing wavelength converter of claim 6, further comprising first and second barrier layers that respectively cover said first and second substrates, said first and second substrates being stacked between said first and second barrier layers.

8. The quantum dot-containing wavelength converter of claim 7, wherein at least one of said first and second barrier layers is made from a composition containing an organic-inorganic oxide hybrid polymer.

9. The quantum dot-containing wavelength converter of claim 8, wherein said inorganic-organic oxide polymer has a formula of SiᵤTiᵥO_{4-z}/OG, wherein 0.01<u<0.99, 0.01<v<0.99, −2<z<2, and OG represents organic molecules.

10. The quantum dot-containing wavelength converter of claim 7, wherein at least one of said first and second barrier layers is made from ethylene-vinyl acetate or TiO₂.

11. The quantum dot-containing wavelength converter of claim 6, wherein said first and second substrates are made from a material selected from the group consisting of glass, polyethylene terephthalate, methyl methacrylate, and polymethyl methacrylate.

12. The quantum dot-containing wavelength converter of claim 5, further comprising a transparent substrate and a first barrier layer, said first and second matrix layers being stacked between said substrate and said first barrier layer.

13. The quantum dot-containing wavelength converter of claim 12, further comprising a second barrier layer covering said substrate.

14. The quantum dot-containing wavelength converter of claim 13, wherein at least one of said first and second barrier layers is made from a composition containing an organic-inorganic oxide hybrid polymer.

15. The quantum dot-containing wavelength converter of claim 14, wherein said inorganic-organic oxide polymer has a formula of SiᵤTiᵥO_{4-z}/OG, wherein 0.01<u<0.99, 0.01<v<0.99, −2<z<2, and OG represents organic molecules.

16. The quantum dot-containing wavelength converter of claim 1, wherein x varies over the layer thickness of said inner shell when x is less than 1.

17. The quantum dot-containing wavelength converter of claim 1, wherein A1 is Se and A2 is S.

18. The quantum dot-containing wavelength converter of claim 17, wherein M1 is Zn, M2 is Cd, and x is less than 1.

19. The quantum dot-containing wavelength converter of claim 1, wherein M1 is Cd, M2 is Zn, and x is less than 1.

20. The quantum dot-containing wavelength converter of claim 1, wherein said compound M1ₓM2₁₋ₓA1_{y}A2_{1-y} is doped with an element A3 that is different from A1 and A2 and that is selected from the group consisting of Se, S, Te, P, As, N, I and O.
